(19) United States
(12) Patent Application Publication
(10) Pub. No.: US 2010/0125571 A1
(43) Pub. Date: May 20, 2010

(54) APPARATUS AND METHODS FOR CREATING WEB LOGS (BLOGS) CONTAINING MEDIA COMMENTARY

(75) Inventor: William MacDonald White, Sausalito, CA (US)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/275,098

(22) Filed: Nov. 20, 2008

(51) Int. Cl. G06F 17/30

(52) U.S. Cl. 707/722; 707/E17.001

(57) ABSTRACT

Disclosed are apparatus and methods for facilitating the formation of remix web logs (blogs) containing commentary about one or more media objects based on one or more selected media objects obtained from one or more selected other blogs. A media object may take any suitable form such as a photograph, a video or audio object, a text excerpt (e.g., from a book or news article), an embedded audio and/or video player, etc. In specific embodiments, the media objects (of both the remix blog and the original source blogs) each take the form of a link or reference (e.g., mp3 link). The commentary about each media object may be created by the creator of the remix blog and/or may be obtained from the original source blogs if available. That is, one or more of the media objects of the remix blog are associated with commentary that was written or created by the remix blogger and/or the original source blogger.

### BACKGROUND OF THE INVENTION

The present invention relates to techniques for facilitating the creation of online blogs (web logs) which contain media content, such as music or video blogs that contain links to audio and/or video objects.

In the past, people who wished to learn about new media, such as new music or movies, would listen to broadcast programming, such as through their local television or radio stations. As the number of channels has increased (e.g., through digital cable), the number and type of media sources has not necessarily increased significantly. Additionally, even when the amount of media sources has increased, this increase has not necessarily enhanced the media consumption experience. For example, in recent years online music subscription services have provided sources for consumers to browse media and purchase desired media objects, e.g., in the form of downloaded mp3 files or the like. Although such media outlets provide a large quantity of media content, it is sometimes a daunting task for an individual to find media that may appeal to him or her. Additionally, a narrow range of popular music is often featured so that the consumer is inundated with the same media content. As a result of the repetitive promotion of certain media content, users often become bored with the available media, e.g., tired of hearing Britney Spears songs.

Media bloggers (e.g., music bloggers) often provide access to new media, such as independent artists. Although users may enjoy browsing media bloggers to learn about new media content, such users may wish to retain information regarding media content that they have found. Although a user may bookmark particular media blog entries for later access, improved mechanisms for utilizing media blog entries are needed.

### SUMMARY OF THE INVENTION

Apparatus and methods for facilitating the creation of remix web logs (blogs) containing media content (e.g., links to audio, video, or text objects/files) based on selected media from selected blogs are provided. In one embodiment, when a plurality of blogs are selected to be used as sources of media content for a remix blog, a plurality of media objects obtained from such selected blogs and provided in a selectable format. When one or more of the provided media objects are selected, the selected one or more media objects are combined so as to form a remix blog in a presentable format.

In a specific implementation, the media objects comprise links to audio and/or video objects. In a further aspect, any commentary that is associated with each of the media objects is obtained from the selected blogs. Each of the selected one or more media objects is combined with any associated, obtained commentary so that each of the selected one or more media objects is presented along with any associated commentary in the remix blog. In yet a further aspect, obtaining any commentary for each selected blog is accomplished by obtaining a feed source for each selected blog and searching in each feed source for any commentary in the form of a link and an item title and/or description and/or content:encoded elements of an RSS (Really Simple Syndication) feed or an entry title, link and/or content elements of an ATOM feed.

In another embodiment, at least one of the selected one or more media objects are combined with commentary that is provided by a creator of the remix blog. In yet another embodiment, the media objects further comprise links to text objects. In an alternative embodiment, only a subset of one or more media objects from a particular selected blog are selected and used to form the remix blog.

In another embodiment, the invention pertains to an apparatus comprising a processor and memory. The processor and memory are configured for performing one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1A is diagrammatic representation of an example blog containing media content.

FIG. 1B is a diagrammatic representation of another example blog in the form of a music blog.

FIG. 2 is a diagrammatic representation of a remix blog containing various types of media content in accordance with a specific implementation of the present invention.

FIG. 3 is a flow chart illustrating a procedure for creating a remix blog in accordance with one embodiment of the present invention.

FIG. 4 is a diagrammatic representation of a screen shot for initiating the creation of a remix blog in accordance with a specific implementation of the present invention.

FIG. 5 is a diagrammatic representation of a screen shot for selection of media objects and their associated commentary from a selected source blog in accordance with a specific implementation of the present invention.

FIG. 6 is a diagrammatic representation of a screen shot for adding media objects and associated commentary to a remix blog from a selected source blog in accordance with one embodiment of the present invention.

FIG. 7 is a diagrammatic representation of a screen shot of a new remix blog based on the playlist of FIG. 6 in accordance with one embodiment of the present invention.

FIG. 8 is a diagrammatic representation of a screen shot for providing information regarding a new remix blog in accordance with a specific embodiment of the present invention.

FIG. 9 is a simplified diagram of a network environment in which specific embodiments of the present invention may be implemented.

FIG. 10 illustrates an example computer system in which specific embodiments of the present invention may be implemented.

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general, embodiments of the present invention include mechanisms for facilitating the formation of remix web logs (blogs) containing commentary about one or more media objects based on one or more selected media objects obtained from one or more selected other blogs. A media object may take any suitable form such as a photograph, a video or audio object, a text excerpt (e.g., from a book or news article), an embedded audio and/or video player, etc. In specific embodiments, the media objects (of both the remix blog and the original source blogs) each take the form of a link or reference (e.g., mp3 link). The commentary about each media object may be created by the creator of the remix blog and/or may be obtained from the original source blogs if available. That is, one or more of the media objects of the remix blog are associated with commentary that was written or created by the remix blogger and/or the original source blogger.

A detailed implementation for facilitating creation of remix blogs will now be described. Although the following techniques and systems of the present invention are described in relation to certain types of media objects, such as audio and video clips and certain types of commentary, such as song or video reviews, of course, similar remix blog creation mechanisms may be used with any suitable type of media objects and any suitable type of associated commentary. By way of examples, the techniques and apparatus of the present invention may operate to facilitate the creation of remix blogs that include reviews about specific hardcopy or electronic books, news articles, or magazine articles, video clips (e.g., movies, television shows, short video clips, etc.), audio clips (e.g., songs, albums, etc.), blog excerpts, etc.

Each review or commentary piece may be associated with a particular media object that is related in some way to the review. An associated media object may take the form of a link to a photograph related to the review (e.g., photograph of the book cover of the book being reviewed, a photograph from the book being reviewed, or a photograph related to the book being reviewed), a text excerpt (e.g., from the book or article being reviewed), an audio clip (e.g., mp3 file), video clip, etc. Each media object may take the form of a link or reference (universal resource locator link). Although commentary is described herein as having a text format, other types of formats, such as video or audio commentary, are also contemplated.

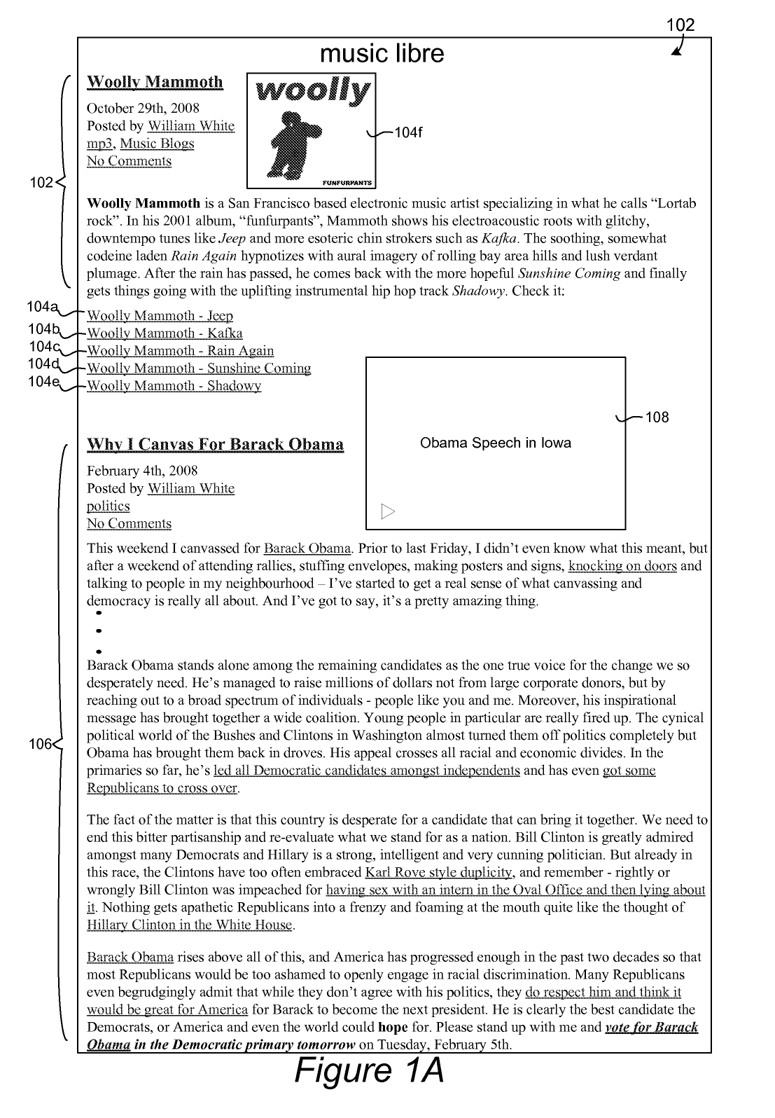

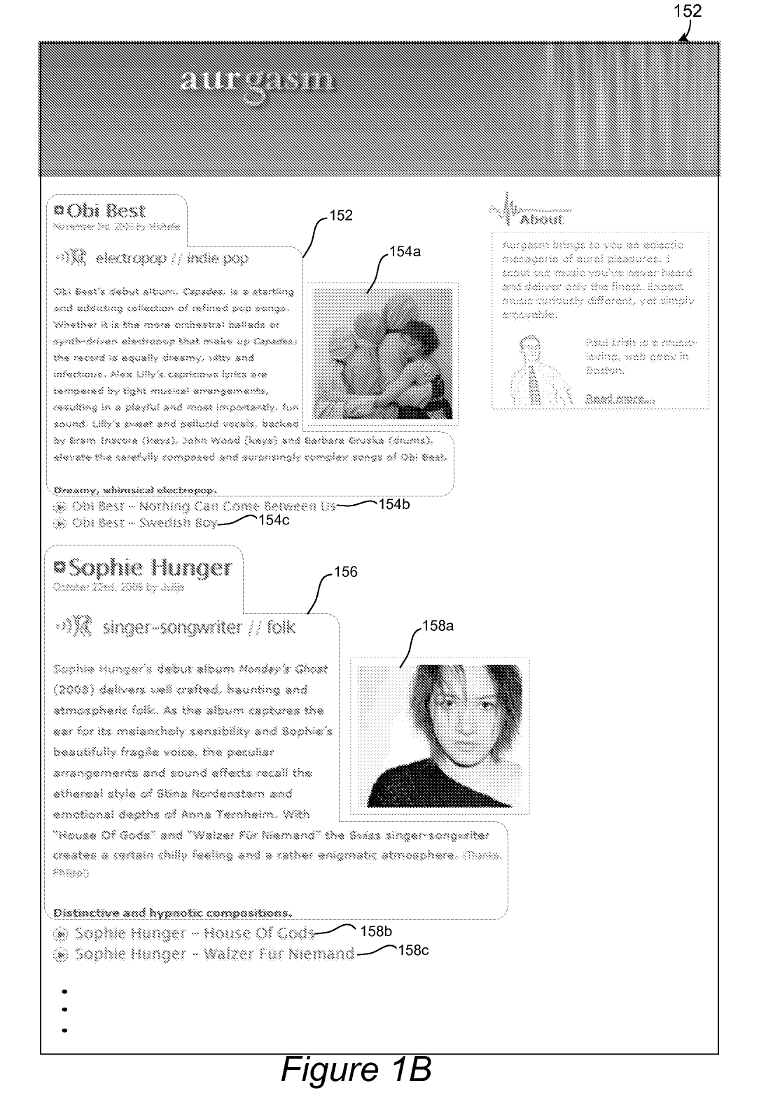

FIG. 1A is a diagrammatic representation of an example blog 102 containing media content. This blog 102 is entitled “music libre” and is currently maintained by blogger William White. As shown, the “music libre” blog 102 includes a first set of commentary 102 that is associated with a plurality of media objects 104a˜104f and second set of commentary 106 associated with a single media object 108. The first set of media objects 104a˜104f include links to audio clips 104a˜104e and a link to a photograph 104f, while the second commentary's media object 108 is in the form of a video clip.

The first commentary 102 includes the artist name Woolly Mammoth, date, the blog poster's name William White, keywords (mp3 and music blogs), and a review of the artist Woolly Mammoth. This commentary 102 is also associated with several links to Woolly Mammoth songs: Jeep, Kafka, Rain Again, Sunshine Coming, and Shadowy. A photograph media object 104f which displays artwork from an album released by Woolly Mammoth is also associated with this commentary 102.

The second commentary 106 also includes a title, date, blogger identifier, and key word and relates to the blogger's experience while campaigning for U.S. presidential candidate Barack Obama, as well as his thoughts on Barack Obama on becoming president. A video clip 108 of an Obama speech in Iowa during the campaign is associated with this commentary 106.

FIG. 1B is a diagrammatic representation of another example of a well known music blog 150 “Aurgasm” created by music blogger Paul Irish. Two excerpts from this Aurgasm music blog are shown although this music blog typically contains numerous posts. The first excerpt includes commentary 152 that is associated with two audio links 154b and 154c and a photograph 154a. The second excerpt includes commentary 156 associated with two audio links 158b and 158c, as well as a photograph 158a. The first commentary 152 is a review of the band Obi Best's debut album, Capades, while the second commentary is a review of the artist Sophie Hunger's debut album, Monday's Ghost (2008). Each commentary piece is also associated with tracks from their respective album being reviewed. For instance, the review on Obi Best is associated with links to the songs “Nothing Can Come Between Us” and “Swedish Boy”, while the review on Sophie Hunger is associated with links to the songs “House of Gods” and “Walzer Fur Niemand”.

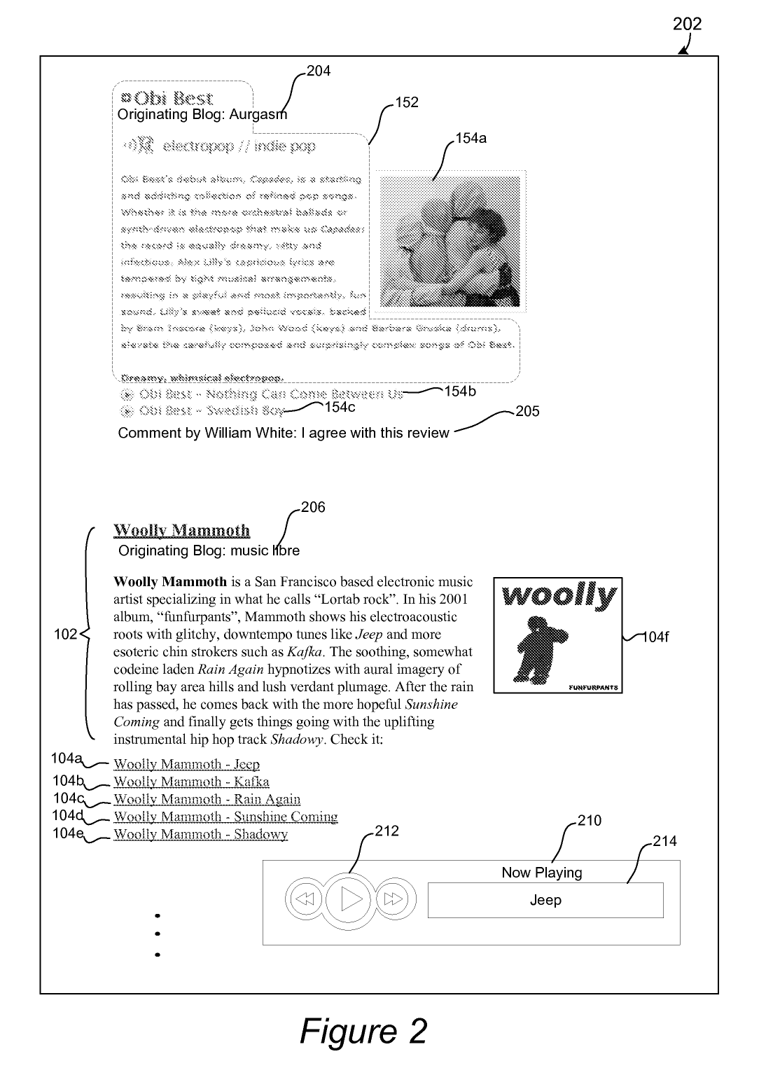

A remix blogger may utilize mechanisms of the present invention to form a remix blog that includes media objects from other originating blogs. The commentary that is associated with the media objects in the originating blogs may also be used within the remix blog. The remix blogger may also add his/her own commentary regarding such media objects. FIG. 2 is a diagrammatic representation of a remix blog 202 (created by William White) in accordance with a specific implementation of the present invention. In this example, this remix blog 202 includes commentary 152 and associated media objects 154a˜154c pertaining to the artist Obi Best from originating blog Aurgasm 204, as well as commentary 205 from the remix blogger William White. The remix blog 202 also includes commentary 102 and associated media objects 104a˜104f pertaining to the artist Woolly Mammoth from originating blog “music libre” 206.

It should be noted that each originating blog excerpt may include attribution to the originating blogger (e.g., 204 and 206). Additionally, the remix blog may include all or any number of selected media objects from a particular originating blog or pertaining to a particular commentary piece from a particular originating blog. Although all of the media objects 104a˜104f pertaining to commentary 102 are selected and included in the illustrated remix blog 202, specific media objects (e.g., 104a and 104f) may be selected and included in the remix blog 202, along with the associated commentary 102, while excluding other media links (e.g., 104b˜e).

The remix blog 202 may also include a media player 210 for playing selected media objects, such as mp3 links. As shown, the media player 210 is in the form of an embedded audio player having controls 212 for playing a selected song 214. The media player may be obtained from the originating blog or created especially for the remix blog.

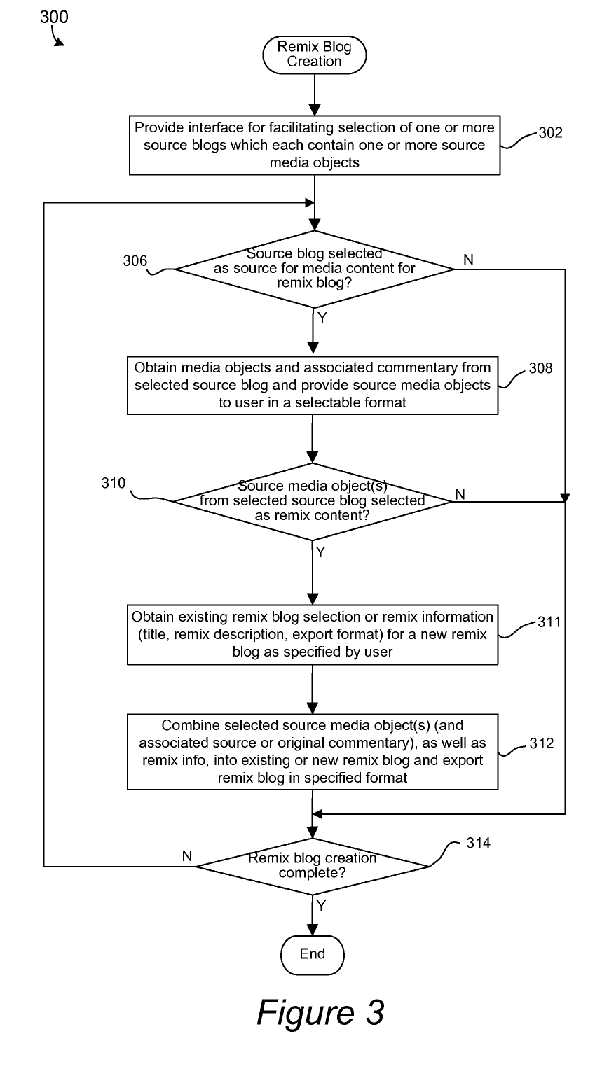

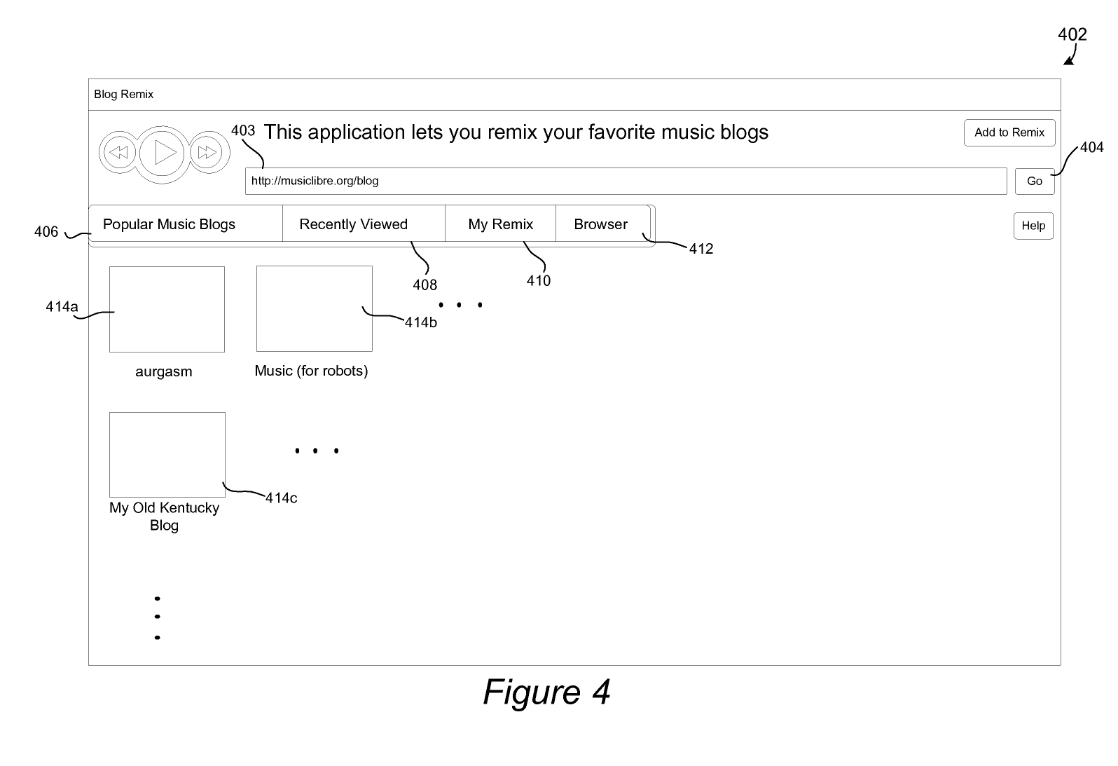

FIG. 3 is a flow chart illustrating a procedure 300 for creating a remix blog in accordance with one embodiment of the present invention. Initially, an interface for facilitating selection of one or more source blogs which each contain one or more media objects may be provided in operation 302. FIG. 4 is a diagrammatic representation of a screen shot 402 for initiating the creation of a remix blog in accordance with a specific implementation of the present invention. When a user executes Blog Remix software, for example, the user may be presented with this initial interface 402 for creating a remix blog.

Referring back to FIG. 3, it may also be determined whether a source blog has been selected as a source for media content for a remix blog in operation 306. A user may select a source blog from which media content may be used for a remix blog in any suitable manner. In the illustrated example of FIG. 4, the user may enter a URL (universal resource locator) for a particular source blog into an input box 403 and then select a “Go” button 404 or select from a plurality of displayed source blogs, e.g., 414a˜414c. As shown, a user may select a “Popular Music Blogs” button 406 for displaying a set of popular blogs, e.g., 414a˜414c or select a “Recently Viewed” button 408 for displaying source blogs that were recently viewed by the user, e.g., in the same or a different remix creation session. In either case, the user may then select from among the displayed popular or recently viewed source blogs.

A “Browser” button 412 may also be provided so that the user can look or search for source blogs using any suitable browser, such as Internet Explorer or Firefox. In a specific implementation, a client (e.g., user device) may also be configured with an agent to intercept requests from the client for any blog, such as a blog page request to a particular service provider, for example, before forwarding such request to its service provider. For instance, the client browser may include an agent in the form of a plug-in that receives URL requests made by the user for particular web pages. The agent can serve as an intermediary software layer between the browser and web servers. Accordingly, any number and type of data (e.g., the web page, as well as with other information such as an identification of the user, the web page identification and/or URL, and timestamps for accessing and exiting such requested page, etc.) may be collected from a user (e.g., with permission) to facilitate remix blog creation. For example, this information may be later used to present recently viewed source blogs to the user.

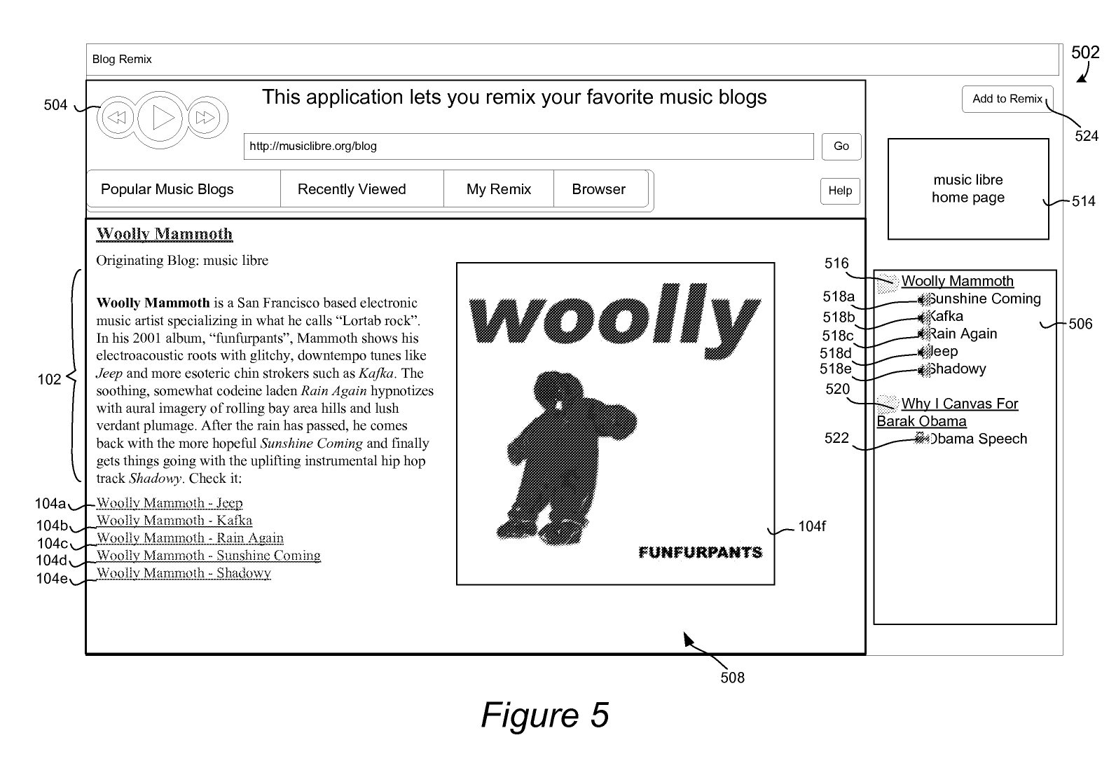

When a source blog is selected, media objects and their associated commentary may then be obtained from the selected source blog and such media objects may be provided to the user in a selectable format in operation 308 (FIG. 3). FIG. 5 is a diagrammatic representation of a screen shot 502 for selection of media objects and their associated commentary from a selected source blog in accordance with a specific implementation of the present invention. In the example of FIG. 4, when the user enters the URL for the music blog “music libre”, the resulting screen shot 502 as illustrated in FIG. 5 can include media objects and associated commentary from the selected source blog “music libre” in a selectable list, e.g., window 506. In one embodiment, each media object of the selected source blog is presented as a selectable object so that the user can view or listen to the corresponding media object. As shown, the user may select audio links 518a˜518e, which correspond to audio files, so as to play such audio files. Similarly, the user can select video link 522, which corresponds to a video, so as to play such video. The interface 502 for selecting media content from a selected source blog may also contain a selectable home page link 514 for the selected source blog,

In the illustrated embodiment, the selectable links (e.g., 518a˜518e and 522) are also arranged in groups corresponding to associated commentary. In the illustrated embodiment, a title is presented for each commentary piece and the corresponding selectable links are displayed under such title in a collapsible folder format. For example, selectable audio links 518a˜518c corresponding to song media objects 104a˜104e are displayed under the commentary title “Woolly Mammoth” 516, which corresponds to the particular artist for such songs. Similarly, a selectable video link 522 corresponding to a video media object are displayed under the commentary title “Why I Canvas For Barack Obama” 520.

The screen shot 502 for a selected source blog may also contain a display area 508 which allows the user to view particular commentary portions that correspond to specified media objects. The display area may also illustrate how a selected media object and its associated commentary would be displayed in the remix blog. In the illustrated example, commentary 102 and all of its associated media objects 104a˜104f are displayed in source blog list window 508 when any of the audio type media objects 518a˜518e or the commentary title 516 is selected by the user. In this example, the originating blog “music libre” is also specified, along with the commentary 102, in display area 508.

When a source blog is selected, any suitable mechanisms may be used to obtain one or more media objects and associated commentary from such selected source blog. The specific process for obtaining a media object depends on the level of sharing capability of the particular source blog and its media objects and commentary. A five level system for categorizing how well music bloggers share their content has been devised by the current Applicant. Although this five level system is described in relation to music blogs, a similar system may be devised for other types of media blogs, e.g., containing video and text objects.

A blog is categorized at a level 4 when such blog is completely open so that media objects and their associated commentary may be easily obtained for use in remix blog. For instance, the blog has a recognizable syndication feed in place (e.g., the feed is autodiscoverable) and uses a feed format that associates commentary with particular media objects in a standard, recognizable manner. In a specific implementation, the “content:encoded” extension of RSS (Really Simple Syndication) feed protocol or the “content” element of the ATOM feed protocol is used to associate commentary with a particular media link. The level 4 blog is also configured to share the full content of each commentary post (i.e., not merely a summary) in the syndication feed. Additionally, level 4 blogs embed direct links with recognizable audio file extensions, such as “.mp3” extensions, in URLs. Level 4 blogs may also provide metadata describing the media assets they link to, either through the use of an HTML microformat such as hAudio, or by using de facto standards, such as putting the artist name and song title in each link, separated by a “-”. Eg. “<ahref=“http://www.mp3blog.com/audio/obi best_-_swedish_boy.mp3”>Obi Best-Swedish Boy</a>”.

A blog may be determined to be at level 4 when such blog has a recognizable syndication feed that utilizes a recognizable format for associating commentary with recognizable audio links. When a level 4 blog is selected as a source blog, media object links can be obtained by obtaining the syndication feed's source and then searching for links with audio extensions (e.g., .mp3) and associated commentary format (e.g., “content:encoded” for RSS feeds or “content” for ATOM feeds) in such feed source.

A blog is categorized as level 3 when it has a recognizable feed (e.g., autodiscoverable) and, like level 4 blogs, uses a recognizable format for associating commentary with recognizable links. However, a level 3 blog does not contain the entire post in the feed source, but only contains a summary of the commentary. In this case, the entire commentary cannot be included in the remix blog. However, the summarized commentary and a link to the originating blog can be included in the remix blog.

A blog is categorized as level 2 when it has a recognizable feed, but such feed does not provide any media enclosures or links. However, the level 2 blog does embed HTML audio links in a manner that is recognizable. Although media objects can be obtained from a level 2 blog, the associated commentary may not be easily obtained.

A level 1 blog does not have a recognizable syndication feed in place. For instance, the feed is not autodiscoverable by the particular web browser; there is not an RSS or ATOM feed icon when the browser goes to such level 1 blog. However, a level 1 blog embeds audio links in a conventional format, such as a link with an “.mp3” extension. Similar to level 2, media objects can be obtained from a level 1 blog without their associated commentary.

A blog is categorized at a level 0 when the blogger embeds audio links in an unconventional manner, possibly with Javascript or by using special hosting services which provide audio links (e.g., mp3 links) with unconventional URL's which cannot be identified as audio links. For example, the extension “.mp3” is not used in the URL link.

When a blog has a closed format (e.g., categorized at a 0 level), other techniques may be used to obtain the media links and associated commentary. Bloggers may wish to use a closed format so that users cannot easily copy or download links, such as mp3 files. The blogger may still wish to share commentary regarding a specific media object, such as an artist, song, or video. To accomplish this sharing while limiting media link access, a relatively closed blog may use a standardized microformat, such as hAudio, to specify metadata associated with an audio recording. For instance, metadata may specify one or more of the following in a source blog: title, album, contributor/artist, track is album, section in pod cast, aria in opera, etc. The metadata may also specify commentary/description and from where the audio recording may be downloaded (e.g., and purchased).

When a source blog uses a microformat, metadata regarding a particular media object may be readily obtained for use in the remix. A link may also be obtained from the specified download metadata. For example, an mp3 file may be bought and downloaded from the specified site for inclusion in the remix blog.

Referring back to FIG. 3, once media objects and associated commentary (if available) are provided in a selectable format, it may also be determined whether one or more source media objects from the selected source blog have been selected as remix content in operation 310. Referring back to FIG. 5, a user may select particular media objects (and associated commentary) in a number of ways. For example, the user may select a single media object, e.g., 518a, and then select the “Add to Remix” button 524 so that this single media object and the associated commentary are selected for adding to a remix blog. In alternative embodiments, the user may select a particular commentary title, e.g., 516, and then select the “Add to Remix” button 524 so that the corresponding commentary and all of the associated media objects are selected for adding to a remix blog.

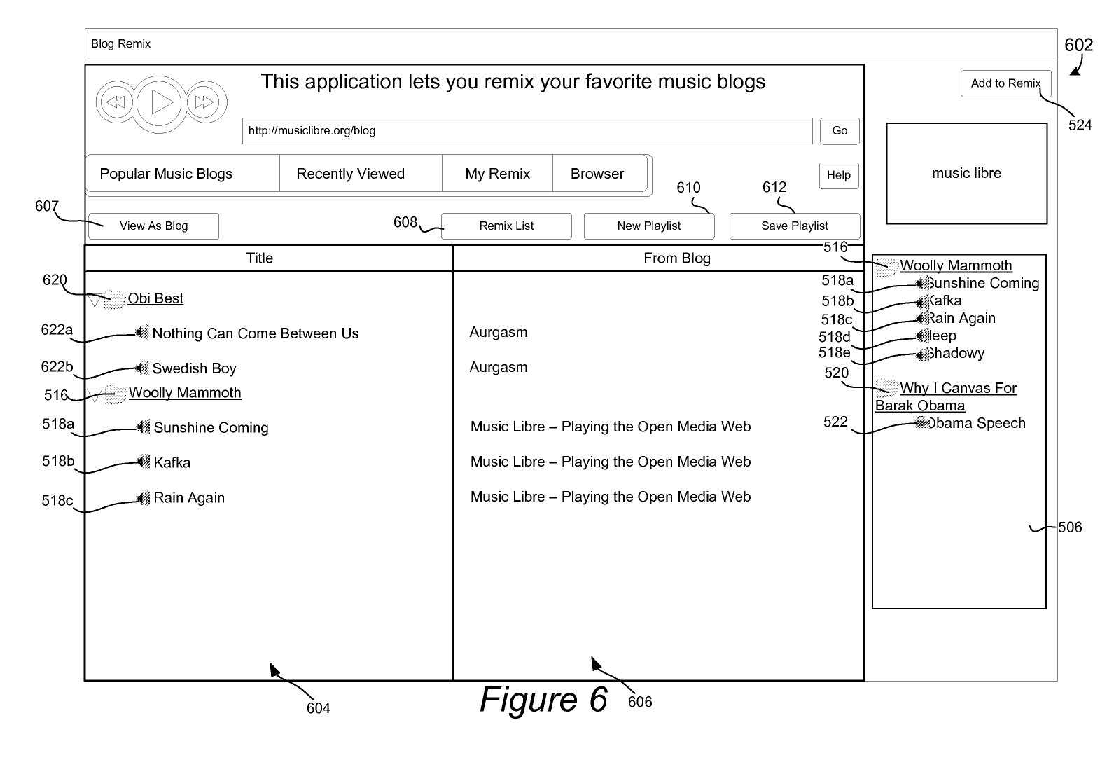

After the “Add to Remix” button 524 is selected, the user may be presented with an interface for adding additional media objects to the remix blog. FIG. 6 is a diagrammatic representation of a screen shot 602 for adding media objects and associated commentary to a remix blog from a selected source blog in accordance with one embodiment of the present invention. As shown, a playlist window 604 containing selected media objects and associated commentary titles may be displayed. An originating blog window 606 may also be displayed alongside this playlist window 604 to specify from which source blog each media object is obtained. As shown, media objects 622a and 622b and commentary 620 (shown only as a title) have already been obtained from previously selected source blog “Aurgasm”, while media objects 518a, 518b, and 518c and commentary 516 (shown only as a title) have been selected from currently selected source blog “music libre.”

In a playlist type view, a user may select additional media objects from a currently selected source blog. For instance, the user can drag and drop one or more media objects (or a group of media objects via a commentary title) from selectable list window 506 into playlist window 604. Additionally, the user may select a media object (or a group of media objects via a commentary title) from selectable list window 506 and then select the “Add to Remix” button 524.

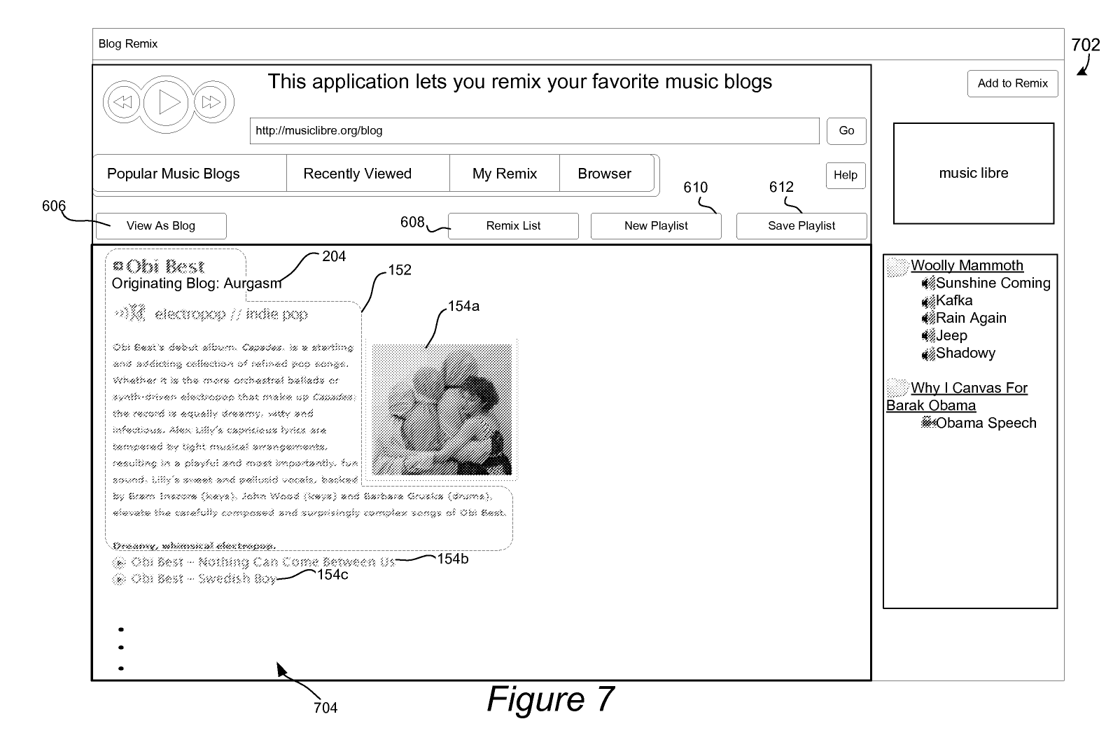

This interface 602 may also include a “View As Blog” button 607 for viewing the currently displayed playlist as a remix blog. FIG. 7 is a diagrammatic representation of a screen shot 702 of a new remix blog based on the playlist of FIG. 6 in accordance with one embodiment of the present invention. As shown, the remix blog is displayed in remix window 704. The remix blog may include the full commentary (if available) associated with each selected media object from each selected source blog as well as identifying the source blog. As shown, commentary 152 from source blog “Aurgasm” (from FIG. 1B) is associated with selected media objects 154a˜154c from source blog “Aurgasm” (from FIG. 1B) and an attribution 204 (from FIG. 2) to source blog “Aurgasm”. Although not shown, the selected media objects 104d, 104b, and 104c (from FIG. 1A) and associated commentary 102 from the source blog “music libre” and attribution 206 (from FIG. 2) would also be displayed in remix window 704 when scrolled down.

Referring back to the remix process of FIG. 3, if media objects are selected, remix information for a new remix may also be obtained as specified by a user in operation 311 and the selected media objects and associated commentary, as well as the remix information, may also be combined into a remix blog and such remix blog may be exported in a specified format in operation 312. For example, a user may select a “Save Playlist” button 612 from the remix creation interface 602 of FIG. 6 and then be presented with an interface for entering information pertaining to the remix blog.

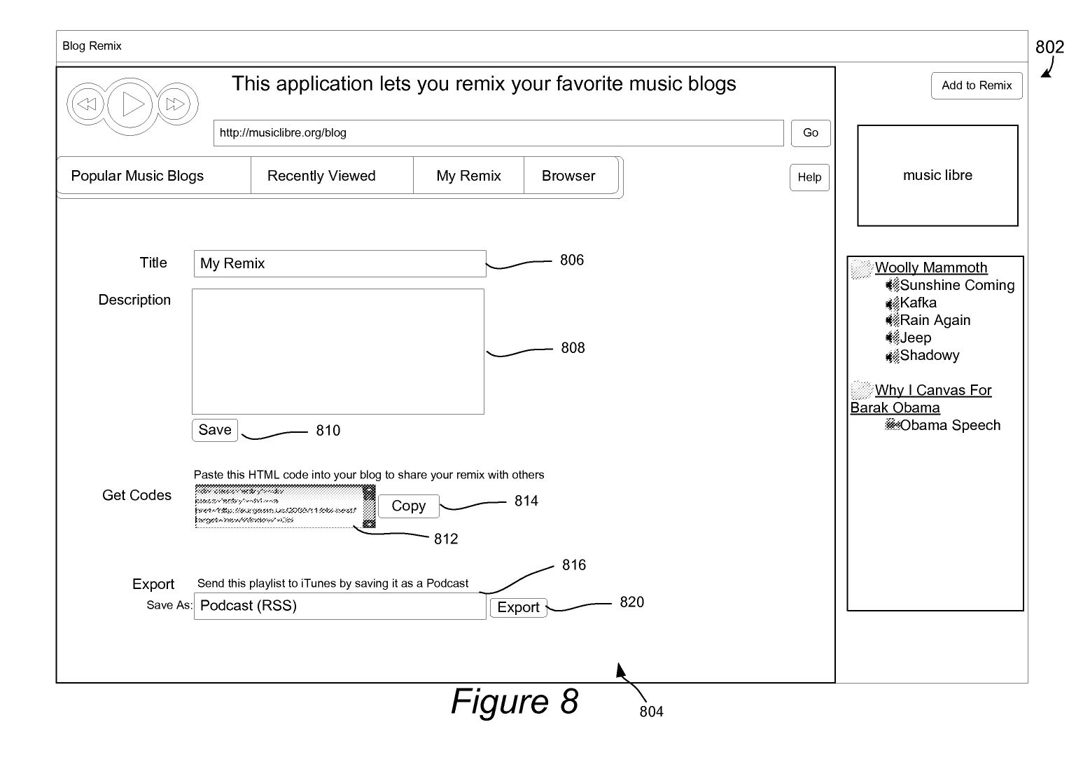

FIG. 8 is a diagrammatic representation of a screen shot 802 for providing information regarding a new remix blog in accordance with a specific embodiment of the present invention. As illustrated, this screen shot 802 includes an input box 806 for inputting a remix title (e.g., “My Remix”), an input box 808 for entering a remix description, a pulldown window 816 for selecting an export format for the remix blog (e.g., RSS, ATOM, HTML, or XSPF). The export formats may include any suitable blog format, such as a syndication feed format (e.g., RSS or ATOM), a web page format (e.g., HTML or Hyper Text Markup Lanaguage), or a playlist format (e.g., XSPF or XML (eXtensible Markup Language) Shared Playlist Format). The remix blog may then be exported in the selected format when the “Export” button 820 is selected.

The remix interface 802 may also include a copy mechanism 814 for copying HTML code 812 into a blog or webpage to share the remix with others. This HTML code can contain the entire content of the blog remix. Remix authors can paste these “codes” directly into their blogging software to publish their remix as a new post on their own blog. Alternatively, the HTML codes can be pasted into an existing HTML page or an entirely new page and uploaded to a website. The remix interface 802 may also include a “Save” button 810 for saving the current playlist and its associated information as specified in interface 802. Of course, multiple playlists may be created with different combinations of media objects from different combinations of source blogs using the techniques and interfaces described above. For instance, the user can specify creation of a new playlist by selection of a “New Playlist” button 610 of the remix creation interface 602 of FIG. 6 and then selecting and adding new media objects for such new playlist as described above.

Referring back to FIG. 3, it may also be determined whether the remix blog creation procedure is complete in operation 314, for example, after selected media objects are combined into a remix blog or no source blog or media object have been selected yet (when operations 306 and 310 are answered in the negative, respectively). For example, the remix blog creation process is complete when a remix blog is created and saved and the user exits the remix process. If the remix blog creation process is complete, the remix procedure may end. Otherwise, another source blog may be selected and other media content may be selected from such selected other source blog to continue to form the current remix blog or another remix blog in operations 306 through 312.

After a particular remix blog is complete, the particular remix blog may then be formed so as to contain links to the selected media objects and associated commentary from other source blogs (e.g., FIG. 2). The selected media objects and associated commentary may be arranged on the remix blog in any suitable manner. For instance, media objects that were placed at the top of the remix playlist during creation may be presented as links and associated commentary at the top of the remix blog. That is, the position order in the remix blog may correspond to the creation playlist order. The remix author may choose to reorder different blog entries until they are satisfied with the ordering. Each media object link in the remix link may be selectable so as to cause the audio or video track to play. A user may also add his or her own commentary to the remix blog with respect to each media object or source commentary.

The remix blog may also contain a media player for playing specific types of media objects (e.g., mp3 files), e.g., as illustrated with respect to FIG. 2. For instance, if the source blog contains a media player (e.g., an audio player), such media player may be obtained as a media object and placed in the remix blog (e.g. embedded at the top or bottom of the blog). Alternatively, a media player may be placed in the remix blog, regardless of whether the source blogs contain a media player and configured to play media object links in the remix page upon selection by the user. The media player can also be configured to automatically sequentially play all media objects in the remix blog or play the top positioned media object link (or any selected single or set of media object links) in the remix blog.

Embodiments of the present invention facilitate the creation of remix blogs from other source blogs. The remix blog, in effect, can be analogous to an audio and/or visual mix-tape, which serves to provide more contextual information about the selected media content. Certain embodiments for forming a remix blog allow a user to easily create an interesting remix blog, adding their own individual commentary, and sharing the remix blog with others, without requiring expertise in blog creation.

Remixing may also promote the original bog creator (e.g., through embedded links back to the original post) and the music (or other media) such creator has blogged about. Remixed media items could also serve as a new metric to identify popular media blogs and popular content items based upon who is getting remixed the most.

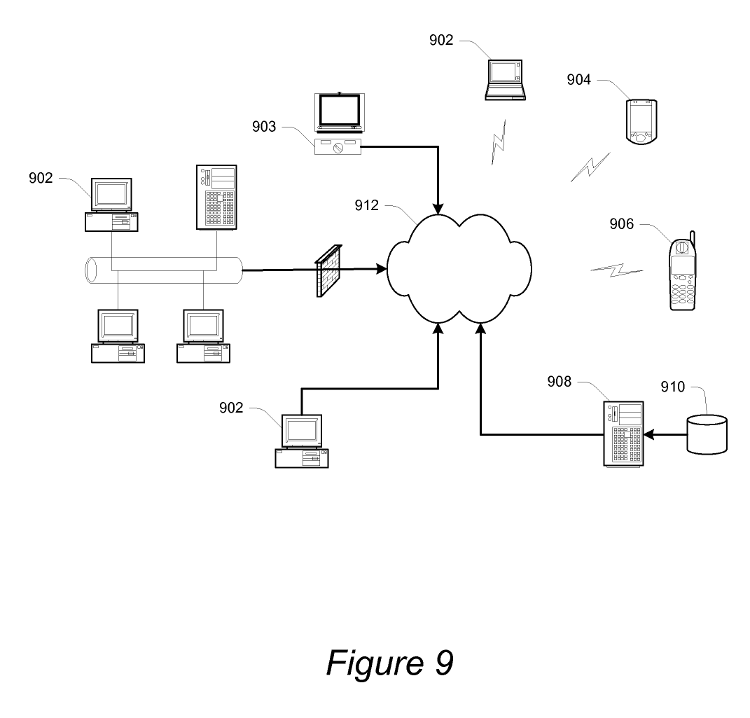

Embodiments of the present invention may be employed to facilitate the creation of remix blogs in any of a wide variety of computing contexts. For example, as illustrated in FIG. 9, implementations are contemplated in which the relevant population of users interact with a diverse network environment via any type of computer (e.g., desktop, laptop, tablet, etc.) 902, media computing platforms 903 (e.g., cable and satellite set top boxes and digital video recorders), handheld computing devices (e.g., PDAs) 904, cell phones 906, or any other type of computing or communication platform.

And according to various embodiments, source blog and media objects and remix information that are processed in accordance with the invention may be obtained and/or read using a wide variety of techniques. For example, source blog and media objects and remix information representing a user's interaction with a local application, web site or web-based application or service may be accomplished using any of a variety of well known mechanisms for receiving input regarding a user's behavior. However, it should be understood that such methods of collecting source blog and media objects and remix information are merely exemplary and that such information may be collected in many other ways.

Once source blog and media objects and remix information have been selected, the source blog and media objects and remix information may be handled according to the invention in some centralized manner. This is represented in FIG. 9 by server 908 and data store 910 that, as will be understood, may correspond to multiple distributed devices and data stores. The invention may also be practiced in a wide variety of network environments (represented by network 912) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

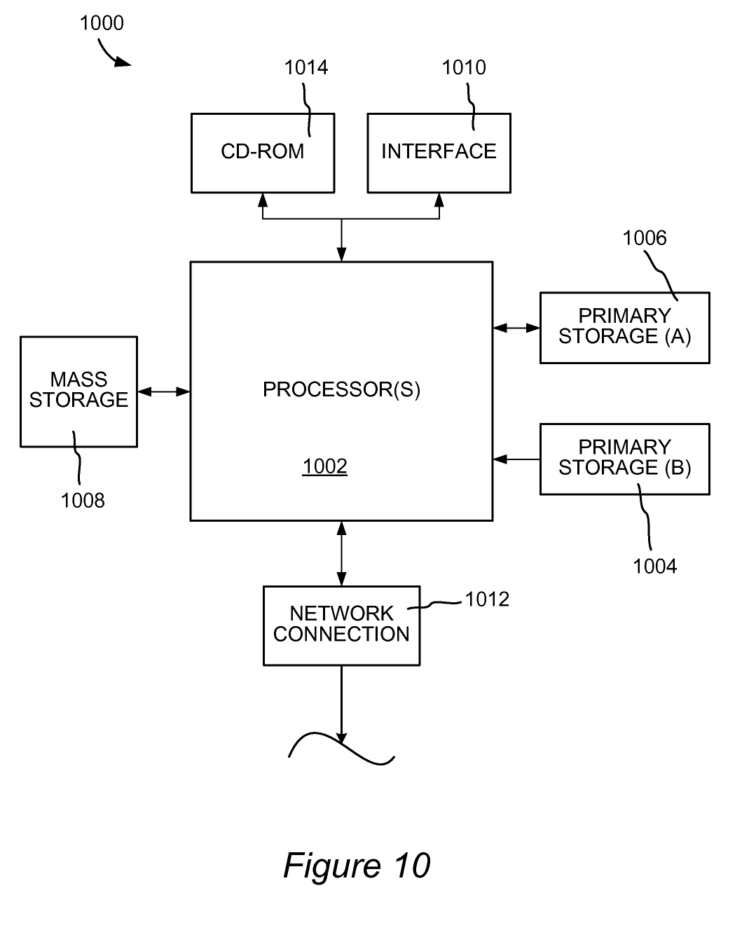

FIG. 10 illustrates a typical computer system that, when appropriately configured or designed, can facilitate various aspects of a live jam session of this invention. The computer system 1000 includes any number of processors 1002 (also referred to as central processing units, or CPUs) that are coupled to storage devices including primary storage 1006 (typically a random access memory, or RAM), primary storage 1004 (typically a read only memory, or ROM). CPU 1002 may be of various types including microcontrollers and microprocessors such as programmable devices (e.g., CPLDs and FPGAs) and unprogrammable devices such as gate array ASICs or general purpose microprocessors. As is well known in the art, primary storage 1004 acts to transfer data and instructions uni-directionally to the CPU and primary storage 1006 is used typically to transfer data and instructions in a bi-directional manner. Both of these primary storage devices may include any suitable computer-readable media such as those described herein. A mass storage device 1008 is also coupled bi-directionally to CPU 1002 and provides additional data storage capacity and may include any of the computer-readable media described above. Mass storage device 1008 may be used to store programs, data and the like and is typically a secondary storage medium such as a hard disk. It will be appreciated that the information retained within the mass storage device 1008, may, in appropriate cases, be incorporated in standard fashion as part of primary storage 1006 as virtual memory. A specific mass storage device such as a CD-ROM 1014 may also pass data uni-directionally to the CPU.

CPU 1002 is also coupled to an interface 1010 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1002 optionally may be coupled to an external device such as a database or a computer or telecommunications network using an external connection as shown generally at 1012. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store the source blogs and selections, media object links and selections, associated commentary, remix information, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method of facilitating formation of a remix blog containing media objects, comprising:
when a plurality of blogs are selected to be used as sources of media content for a remix blog, obtaining and providing a plurality of media objects from such selected blogs in a selectable format; and
when one or more of the provided media objects are selected, combining the selected one or more media objects so as to form a remix blog in a presentable format.

2. The method as recited in claim 1, wherein the media objects comprise links to audio and/or video objects.

3. The method as recited in claim 2, further comprising:
obtaining any commentary that is associated with each of the media objects from the selected blogs; and
combining each of the selected one or more media objects with any associated, obtained commentary so that each of the selected one or more media objects is presented along with any associated commentary in the remix blog.

4. The method as recited in claim 3, wherein obtaining any commentary for each selected blog comprises:
obtaining a feed source for each selected blog; and
searching in each feed source for any commentary in the form of a link and/or item title and/or description and/or content:encoded elements of an RSS (Really Simple Syndication) feed or an entry title, link and/or content elements of an ATOM feed.

5. The method as recited in claim 1, further comprising combining at least one of the selected one or more media objects with commentary that is provided by a creator of the remix blog.

6. The method as recited in claim 1, wherein the media objects further comprise links to text objects.

7. The method as recited in claim 1, wherein only a subset of one or more media objects from a particular selected blog are selected and used to form the remix blog.

8. An apparatus for facilitating formation of a remix blog containing media objects, comprising at least a processor and a memory, wherein the processor and/or memory are configured to perform the following operations:
when a plurality of blogs are selected to be used as sources of media content for a remix blog, obtaining and providing a plurality of media objects from such selected blogs in a selectable format; and
when one or more of the provided media objects are selected, combining the selected one or more media objects so as to form a remix blog in a presentable format.

9. An apparatus as recited in claim 8, wherein the media objects comprise links to audio and/or video objects.

10. An apparatus as recited in claim 9, wherein the processor and/or memory are further configured to perform the following operations:
obtaining any commentary that is associated with each of the media objects from the selected blogs; and
combining each of the selected one or more media objects with any associated, obtained commentary so that each of the selected one or more media objects is presented along with any associated commentary in the remix blog.

11. An apparatus as recited in claim 10, wherein obtaining any commentary for each selected blog comprises:
obtaining a feed source for each selected blog; and
searching in each feed source for any commentary in the form of a link and/or item title and/or description and/or content:encoded elements of an RSS (Really Simple Syndication) feed or an entry title, link and/or content elements of an ATOM feed.

12. An apparatus as recited in claim 8, wherein the processor and/or memory are configured to combine at least one of the selected one or more media objects with commentary that is provided by a creator of the remix blog.

13. An apparatus as recited in claim 8, wherein the media objects further comprise links to text objects.

14. An apparatus as recited in claim 8, wherein only a subset of one or more media objects from a particular selected blog are selected and used to form the remix blog.

15. At least one computer readable storage medium having computer program instructions stored thereon that are arranged to perform the following operations:
when a plurality of blogs are selected to be used as sources of media content for a remix blog, obtaining and providing a plurality of media objects from such selected blogs in a selectable format; and
when one or more of the provided media objects are selected, combining the selected one or more media objects so as to form a remix blog in a presentable format.

16. At least one computer readable storage medium as recited in claim 15, wherein the media objects comprise links to audio and/or video objects.

17. At least one computer readable storage medium as recited in claim 16, wherein the computer program instructions stored thereon that are further arranged to perform the following operations:
obtaining any commentary that is associated with each of the media objects from the selected blogs; and
combining each of the selected one or more media objects with any associated, obtained commentary so that each of the selected one or more media objects is presented along with any associated commentary in the remix blog.

18. At least one computer readable storage medium as recited in claim 15, wherein obtaining any commentary for each selected blog comprises:
obtaining a feed source for each selected blog; and
searching in each feed source for any commentary in the form of a link and/or item title and/or description and/or content:encoded elements of an RSS (Really Simple Syndication) feed or an entry title, link and/or content elements of an ATOM feed.

19. At least one computer readable storage medium as recited in claim 15, wherein the computer program instructions stored thereon that are further arranged to combine at least one of the selected one or more media objects with commentary that is provided by a creator of the remix blog.

20. At least one computer readable storage medium as recited in claim 15, wherein the media objects further comprise links to text objects.

21. At least one computer readable storage medium as recited in claim 15, wherein only a subset of one or more media objects from a particular selected blog are selected and used to form the remix blog.
